(19) United States
(12) Patent Application Publication
(10) Pub. No.: US 2017/0145795 A1
(43) Pub. Date: May 25, 2017

(54) BEADED MATRIX AND METHOD OF PRODUCING THE SAME

(71) Applicant: Bennett M. Richard, Kingwood, TX (US)

(72) Inventor: Bennett M. Richard, Kingwood, TX (US)

(73) Assignee: Baker Hughes Incorporated, Houston, TX (US)

(21) Appl. No.: 15/402,898

(22) Filed: Jan. 10, 2017

Related U.S. Application Data
(62) Division of application No. 14/298,248, filed on Jun. 6, 2014.

(51) Int. Cl. E21B 43/08; B23K 20/06

(52) U.S. Cl. CPC E21B 43/082; B23K 20/06

(57) ABSTRACT

A method for making a beaded matrix includes positioning two or more beads near one another. Accelerating the two or more beads toward one another; and impacting the two or more beads with one another so that electrons are shared between molecules thereby fusing the two or more beads together.

### CROSS REFERENCE TO RELATED APPLICATIONS

This is a divisional application claims the benefit of an earlier filing date from U.S. Non-Provisional application Ser. No. 14/298,248 filed Jun. 6, 2014, the entire disclosure of which is incorporated herein by reference.

### BACKGROUND

In the downhole exploration and production industry, the movement and production of fluids is central to virtually all relevant operations. In many cases, the fluids that are moved would entrain solids. While in some cases, the entrainment of solids is desirable, such as in gravel and frac packing operations, such entrainment is often undesirable in other operations. One example, of course, is formation sand entrained with the production fluid. This is clearly undesirable as it is both a contaminant in the produced stream and also contributes to expedited wear of downhole components due to a sand blasting effect. Filtering assemblies are consequently used ubiquitously in the industry to remove these entrained solids. Sand screens have been used for decades and generally work well for their intended purposes. More recently, different operating parameters has supported interest in other filtering media such as beaded matrix assemblies.

Beaded matrix assemblies comprise a number of rounded beads that are typically braised together to form a porous solid that is configured during the manufacturing process to fit into a selected housing. One drawback is the impact that the braze has on the porosity of the beaded matrix since the braze itself requires a minimum surface area contact to be strong and is difficult to control as it flows. Braze itself also renders beaded matrixes not NACE compliant, which is increasingly important in downhole installations. Another drawback is that the heat of brazing can be deleterious to the longevity of the resulting products. Since downhole assemblies are long term installations, improvements are always welcomed by the art.

### BRIEF DESCRIPTION

A method for making a beaded matrix includes positioning two or more beads near one another; accelerating the two or more beads toward one another; and impacting the two or more beads with one another so that electrons are shared between molecules thereby fusing the two or more beads together.

A downhole system includes a tubular string positioned in a borehole; and one or more beaded matrix assemblies in fluid communication with the string, the one or more assemblies having two or more beads sharing electrons between their respective molecules forming the matrix.

A NACE compliant downhole system includes a tubular string positioned in a borehole, one or more beaded matrix assemblies in fluid communication with the string, the one or more assemblies having two or more beads sharing electrons between their respective molecules forming the matrix, and an absence of NACE noncompliant materials in the beaded matrix assemblies.

### BRIEF DESCRIPTION OF THE DRAWINGS

FIG. 1 illustrates a beaded matrix in a housing;

FIG. 2 illustrated the surface contact between adjacent beads and in broken lines where a braze bridge would be if bonded with braze rather than the molecular bond taught herein;

FIG. 3 illustrates a molecular interface where electrons are shared between adjacent molecules;

FIG. 4 is a schematic illustration of a thin layer of beaded matrix; and

FIG. 5 schematically illustrates a downhole system including a beaded matrix as disclosed herein.

### DETAILED DESCRIPTION

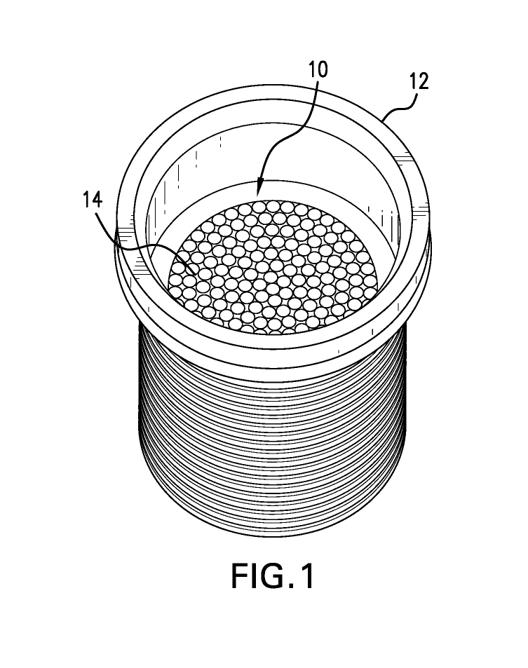

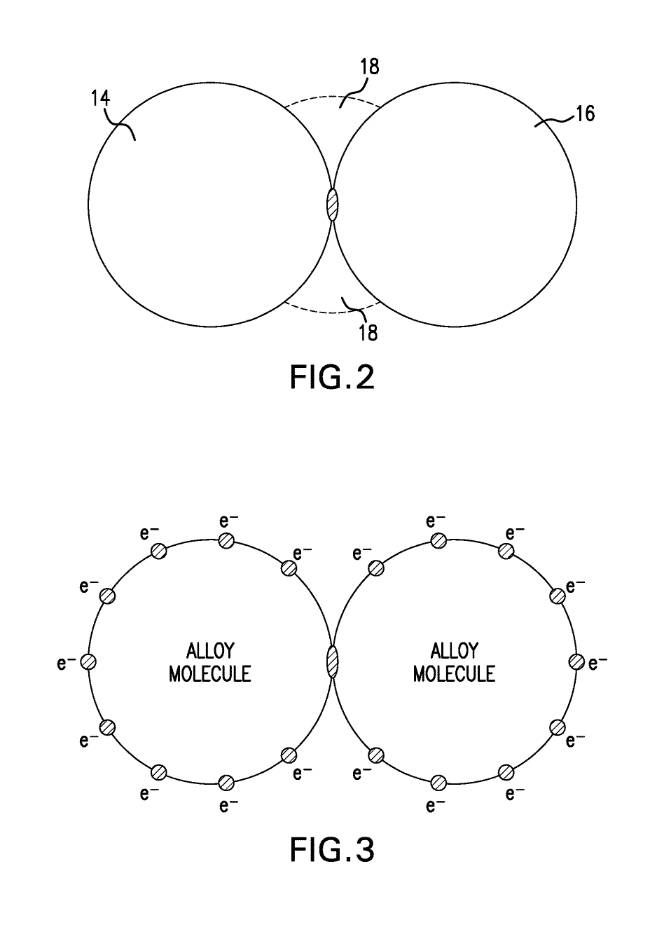

Referring to FIG. 1, a beaded matrix 10 is illustrated within a housing 12. The illustration will be recognized from earlier filings in appearance but the matrix illustrated here is not prior art. Rather it is an improved matrix having enhanced porosity and greater longevity due to avoidance of braze material and avoidance of a heat affected zone caused by heat during the manufacturing process. More specifically, because there is no need to employ a binding composition such as braze, there is nothing to impact the porosity that the beads 14 and 16 themselves create when touching one another without perfectly nesting as will be appreciated by one of skill in the art. Brazed beads require sufficient braze 18 to bond the beads together and necessarily the braze will bridge small gaps where the beads are being bonded together, see broken lines in FIG. 2 which otherwise is intended simply to illustrate a contact point between adjacent beads whereat bonding will take place without braze in accordance with the teachings herein.

The matrix illustrated herein is produced by collecting together a number of beads 14, 16, etc. each comprising a metal alloy, and joining the beads to one another at contact points by magnetic pulse welding or electrohydraulic forming. The processes employed are commercially available from BMAX ZI Thibaud 30 Bd de Thibaud, Toulouse France and utilize a magnetic field in a magnetic pulse welding operation or a hydraulic shock wave in an electrohydraulic forming operation in order to accelerate adjacent components, here the beads, (and hence their molecules) into one another such that the resulting collision causes the molecules to share electrons in their outer valences, see FIG. 3, effectively fusing the molecules together. The fusion is stronger than the base material and yet imposes no ill effect on the base material as would a heat based fusion method. In fact, heat is not applied at all and the fusion takes place at around room temperature so there is no heat affected zone. The bond is stronger than the base material, is completely durable and does not result in a new alloy at the joint. It is also rapid and so enhances efficient manufacturing production times.

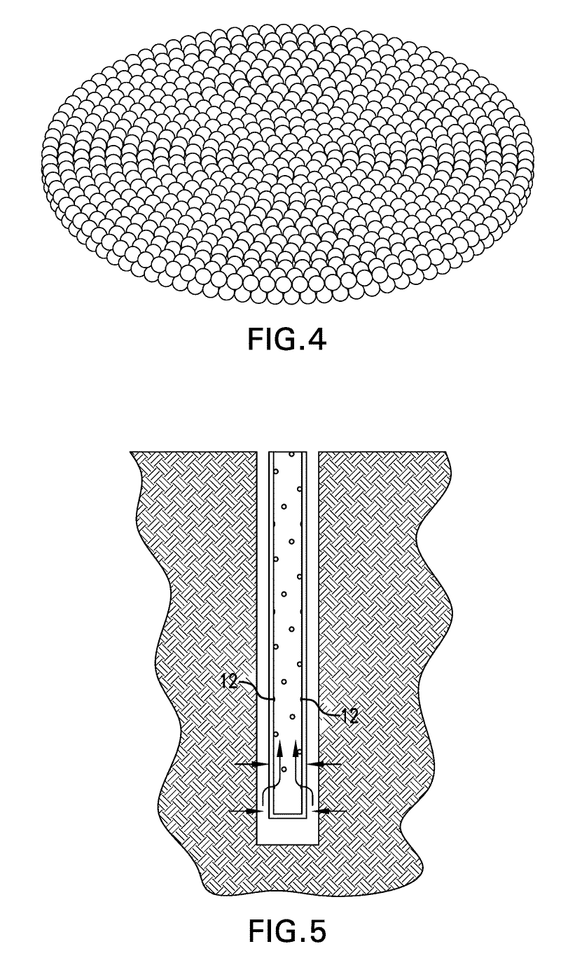

In some embodiments the beaded matrix is formed in thin layers, see FIG. 4, that are subsequently stacked to produce a beaded matrix thickness of a desired measurement that may be about ½ inch to about ¾ inch but is not limited to these measurements. In other embodiments, the matrix is formed as one piece in the desired measurement.

In one embodiment the matrix is formed and positioned within a housing, such as that shown in FIG. 1 or alternatively with added screen material 20, 22 on one or each axial end of the housing (see FIG. 1A). The housing may be preformed or may be formed around the beaded matrix by traditional welding, crimping (conventional processing) or by magnetic pulse welding or electrohydraulic forming. The housing provides the structure to mount the matrix to a downhole component reliably. For example, in some embodiments the housing will be threaded at the outside diameter thereof to screw into a downhole component for mounting thereat.

One advantage of the configuration and method disclosed herein is that the resulting beaded matrixes (using for example nickel chromium alloys or nickel alloys) are NACE compliant which has never been possible in the art because of the braze that has heretofore always been required in order to produce any kind of beaded matrix. Another benefit of the present invention is that the pressure ratings of beaded matrixes produced as taught herein are vastly superior to those of beaded matrixes of the prior art. The pressure ratings achievable with the beaded matrixes of the invention are on the order of six times the psi ratings braze based matrixes normally attain which are limited to on the order of 5,000 psi to 10,000 psi depending of the geometry and size of the media.

Referring to FIG. 5, the inventive beaded matrix is schematically illustrated in a downhole string showing the action of the beaded matrix in filtering incoming production fluids. Utilizing the beaded matrixes disclosed herein, an operator is able to construct a borehole system having superior pressure capability, longevity and flow capability than possible with systems of the prior art. This is in addition to being NACE compliant, which is a clear advantage to any operator in today's downhole industry.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

The teachings of the present disclosure may be used in a variety of well operations. These operations may involve using one or more treatment agents to treat a formation, the fluids resident in a formation, a wellbore, and/or equipment in the wellbore, such as production tubing. The treatment agents may be in the form of liquids, gases, solids, semi-solids, and mixtures thereof Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A method for making a beaded matrix comprising:
positioning two or more beads near one another;
accelerating the two or more beads toward one another; and
impacting the two or more beads with one another so that electrons are shared between molecules thereby fusing the two or more beads together.

2. A method for making a beaded matrix as claimed in claim 1 wherein the accelerating is by a magnetic pulse welding operation.

3. A method for making a beaded matrix as claimed in claim 1 wherein the accelerating is by an electrohydraulic forming operation.

4. A method for making a beaded matrix as claimed in claim 1 wherein the two or more beads are arranged in a thin layer of beads and subsequent to accelerating and impacting, two or more layers are stacked to form a beaded matrix having a selected thickness dimension.

5. A method for making a beaded matrix as claimed in claim 1 wherein the method further comprises producing a housing around the beaded matrix.

6. A method for making a beaded matrix as claimed in claim 5 wherein the producing is by a magnetic pulse welding operation.

7. A method for making a beaded matrix as claimed in claim 5 wherein the producing is by an electrohydraulic forming operation.

8. A method for making a beaded matrix as claimed in claim 5 wherein the producing is by a conventional process.

9. A downhole system comprising:
a tubular string positioned in a borehole; and
one or more beaded matrix assemblies in fluid communication with the string, the one or more assemblies having two or more beads sharing electrons between their respective molecules forming the matrix.

10. A NACE compliant downhole system comprising:
a tubular string positioned in a borehole;
one or more beaded matrix assemblies in fluid communication with the string, the one or more assemblies having two or more beads sharing electrons between their respective molecules forming the matrix; and
an absence of NACE noncompliant materials in the beaded matrix assemblies.
